(19) United States
(12) Patent Application Publication
(10) Pub. No.: US 2021/0248861 A1
(43) Pub. Date: Aug. 12, 2021

(54) SYSTEMS AND METHODS FOR RAFFLE-TYPE GAME PLAY

(71) Applicant: Stephen W. Durrell, Lawrence, KS (US)

(72) Inventor: Stephen W. Durrell, Lawrence, KS (US)

(21) Appl. No.: 17/172,785

(22) Filed: Feb. 10, 2021

Related U.S. Application Data
(60) Provisional application No. 62/972,319, filed on Feb. 10, 2020.

(51) Int. Cl. G07F 17/32

(52) U.S. Cl. CPC G07F 17/329

(57) ABSTRACT

A server includes a database having a game entry table stored thereon. The table including a plurality of game entry records. The server also includes a processor programmed to receive a plurality of game entry requests from several gaming transaction devices. Each of the game entry requests includes a device identifier, a device location, a time of the request, and a sequence number for a game entry. The server generates a unique game entry number for each game entry and transmits the unique game entry number back to the requesting transaction device. The server calculates a first entry influx rate for each of the gaming transaction devices and determines one or more groupings of the gaming transaction devices based on predefined rules and the first entry influx rate for each of the gaming transaction devices. In response to a triggering event, the server selects one of the groupings and, from the selected grouping, a predetermined number of unique game entry numbers. The server then selects one of the unique game entry numbers as the winning number.

### CROSS-REFERENCE TO RELATED APPLICATIONS

This application claims priority to and the benefit of U.S. Provisional Patent Application Ser. No. 62/972,319 filed Feb. 10, 2020, and entitled “SYSTEMS AND METHODS FOR RAFFLE-TYPE GAME PLAY,” which is hereby incorporated by reference in its entirety.

### FIELD OF THE DISCLOSURE

The field of the disclosure relates generally to games of chance and, more particularly, to methods and systems for a raffle-type and/or lottery style game that can adjust game play based on rate of play.

### BACKGROUND OF THE DISCLOSURE

Lotteries have flourished in recent years and competition to attract customers has also increased. In addition, new and young players demand a more immediate result for lottery games they chose to play. The traditional draw games, with their drawings typically occurring after several days of obtaining game play entries, are not as attractive to young and new players. As a result, there is a need for a lottery game that has a more immediate result and that can adjust game play based on the number of players and rates of game play.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a server is provided. The server includes a database including a game entry table having a plurality of game entry records. the server also includes a processor in communication with the database. The processor is programmed to receive a plurality of game entry requests from one or more gaming transaction devices. Each game entry request includes a device identifier, a device location, a time of the request, and a sequence number for a game entry. The processor is also programmed to combine two or more of the device identifier, device location, time of the request, and sequence number to generate a unique game entry number for each game entry. In addition, the processor is programmed to transmit the unique game entry number for each game entry to the requesting transaction device. Furthermore, the processor is programmed to calculate a first entry influx rate for each of the gaming transaction devices and determine one or more groupings of the gaming transaction devices based on one or more predefined rules and the first entry influx rate for each of the gaming transaction devices. Moreover, the processor is programmed to, in response to a triggering event, select one of the groupings and, from the selected grouping, a predetermined number of unique game entry numbers, and select one of the unique game entry numbers from the selected predetermined number of unique game entry numbers.

In another aspect, a method is provided. The method is performed by a server. The method includes receiving a plurality of game entry request data packets from one or more gaming transaction devices via a communication interface. Each game entry request data packet includes data comprising a device identifier, a device location, a time of the request, and a sequence number for a game entry. The method also includes combining two or more of the device identifier, device location, time of the request, and sequence number to generate a unique game entry number for each game entry. Furthermore, the method includes transmitting the unique game entry number for each game entry to the requesting transaction device via the communication device. The method also includes calculating a first entry influx rate for each of the gaming transaction devices using an influx rate module. In addition, the method includes determining one or more groupings of the gaming transaction devices using a grouping module. The one or more groupings is based on one or more predefined rules and the first entry influx rate for each of the gaming transaction devices. The method includes selecting one of the groupings in response to a triggering event, selecting a predetermined number of unique game entry numbers from the selected grouping, and selecting one of the unique game entry numbers from the selected predetermined number of unique game entry numbers.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example gaming network system, in accordance with one embodiment of the present disclosure;

FIG. 2 is an example configuration of a game server, which is part of the gaming service provider shown in FIG. 1;

FIG. 3 is an example configuration of a client system for use in the network system shown in FIG. 1;

FIG. 4 is an example configuration of a server system for use in the network system shown in FIG. 1;

FIG. 5 is a schematic illustration of groupings of a plurality of gaming transaction devices and user devices shown in FIG. 1; and

FIG. 6 is a flowchart illustrating an exemplary computer-implemented method for a raffle-type game based on game entry influx rate, in accordance with one embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oraclex Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

### Network System

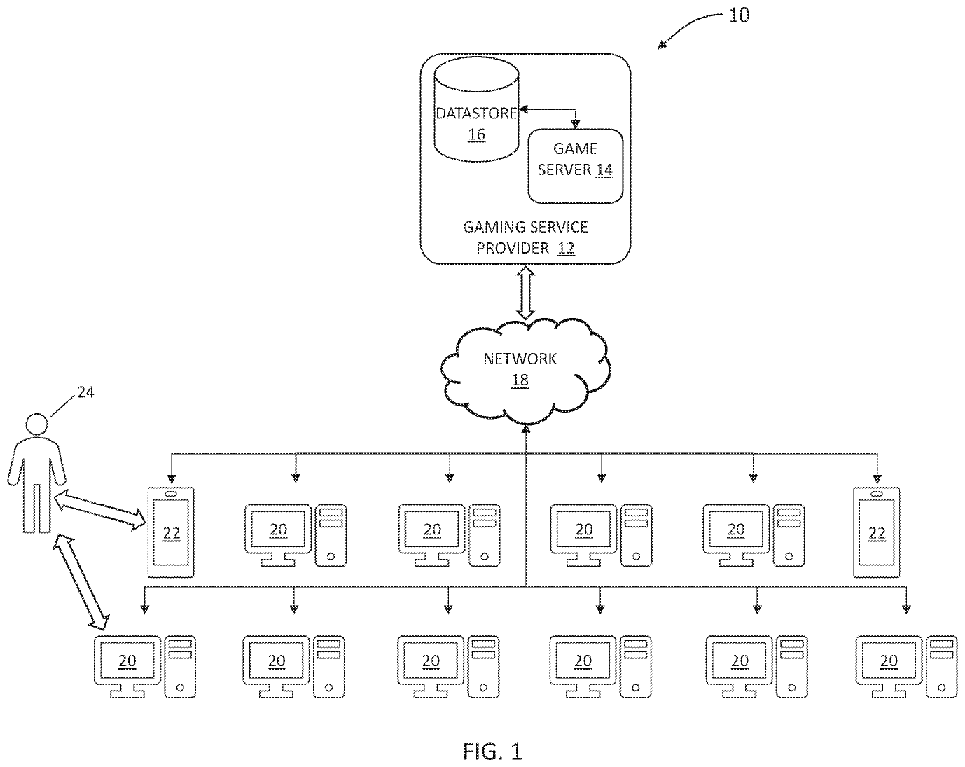

FIG. 1 is a block diagram of an example gaming network system 10, in accordance with one embodiment of the present disclosure. The gaming network system 10 includes a gaming service provider 12 having a game server 14 coupled to a datastore 16. In addition, the gaming network system 10 includes a plurality of gaming transaction devices 20 and/or a plurality of user devices 22. Game players (or users) 24 interact with one or more of the gaming transaction devices and/or user devices to participate in one or more games offered by the gaming service provider 12. To participate in games offered by the gaming service provider 12, the gaming transaction devices 20 and user devices 22 are coupled in communication with the gaming service provider 12, and more particularly, with the game server 14, via a communications network 18. Although parts of the gaming network system 10 are presented in one arrangement, other embodiments may include the same or different parts arranged otherwise, depending, for example, communication between computing devices, etc.

In the example embodiment, the communications network 18 includes, for example and without limitation, one or more of a local area network (LAN), a wide area network (WAN) (e.g., the Internet, etc.), a mobile network, a virtual network, and/or any other suitable public and/or private network capable of facilitating communication among the gaming transaction devices 20, the user devices 22, and/or the gaming service provider 12. In some embodiments, the network 18 includes more than one type of network, such as a private transaction network provided by the gaming service provider 12 to the gaming transaction devices 20 and, separately, the public Internet, which may facilitate communication between the user devices 22 and the gaming service provider 12.

With continued reference to FIG. 1, in the exemplary embodiment, the user device 22 (e.g., a smartphone or other computing device used by the user 24) includes a user interface that facilitates user interaction with the respective user device 22. For example, and without limitation, the user interface enables the user 24 to input information to the user device 22 and the user device 22 to output information to the user 24 (e.g., on a display of the user device 22). The user interface enables interaction with, for example, a gaming application that is installed on the user device 22. In the exemplary embodiment, a gaming application is associated with the gaming service provider 12. It is contemplated that fewer or more software applications may be installed on the user device 22 and displayed by the user interface.

In the example embodiment, the gaming transaction devices 20 are typically associated with a merchant (not shown) that offers for sale to the user 24 one or more entries or chances to play one or more games offered by the gaming service provider 12. Each merchant includes, for example, a physical location and/or a virtual location. A physical location includes, for example, a brick-and-mortar store, etc., and a virtual location includes, for example, an Internet-based store-front.

In the exemplary embodiment, the user device 22 communicates with the gaming service provider 12, for example, via the network 18, to play and/or purchase entries for a game offered by the gaming service provider 12. The user device 22 can be any computing device capable of interconnecting to the network 18, such as the Internet, including a mobile web-based device, smartphone, PDA, or other mobile web-based connectable equipment. The user device 22 is interconnected to the Internet through one or more interfaces including a network, such as a local area network (LAN) or a wide area network (WAN), dial-in-connections, cable modems, wireless modems, and special high-speed ISDN lines.

The gaming service provider 12 includes, for example, and without limitation, a computer, a server, a network of multiple computing devices, a virtual computing device, or the like. The gaming service provider 12 may include, for example, a web application, an application programming interface (API) server, and/or a memory device enabling the gaming transaction devices 20 and the user devices 22 to be in communication with the gaming service provider 12 using, for example, and without limitation, the Internet. The gaming transaction devices 20 and the user devices 22 are interconnected to the Internet through one or more interfaces including a network, such as a local area network (LAN) or a wide area network (WAN), dial-in-connections, cable modems, and special high-speed ISDN lines. The gaming transaction devices 20 and the user devices 22 can be any computing device capable of interconnecting to the Internet.

As discussed above, the gaming service provider 12 includes, for example, a game server 14, which is connected to a datastore 16 (e.g., a database). In one embodiment, the datastore 16 is stored on the gaming service provider 12. In an alternative embodiment, the datastore 16 may be stored remotely from the gaming service provider 12 and may be non-centralized. The datastore 16 is configured to receive and store user account information, game play entries, and/or rules associated with those accounts and/or entries.

In the exemplary embodiment, a user, such as the user 24, participates in a game (e.g., a raffle-type game, lottery game, etc.) by purchasing one or more entries using, for example, a gaming transaction device 20 and/or a user device 22. A user's entries include one or more unique numbers. The game service provider 12 selects a predetermined number of entries (i.e., the unique numbers) in response to a triggering event, wherein the selection criteria is based on one or more rules and/or conditions. After selecting the predetermined number of entries, the gaming service provider 12 selects a random entry from the selected entries, the random entry selected being the winning number (or entry). The unique numbers are issued to the users in metered fashion responsive to the requests in a time order of the requests. When an issued unique number matches a winning number, a prize is paid to the user having the winning number.

### Exemplary Computer Systems

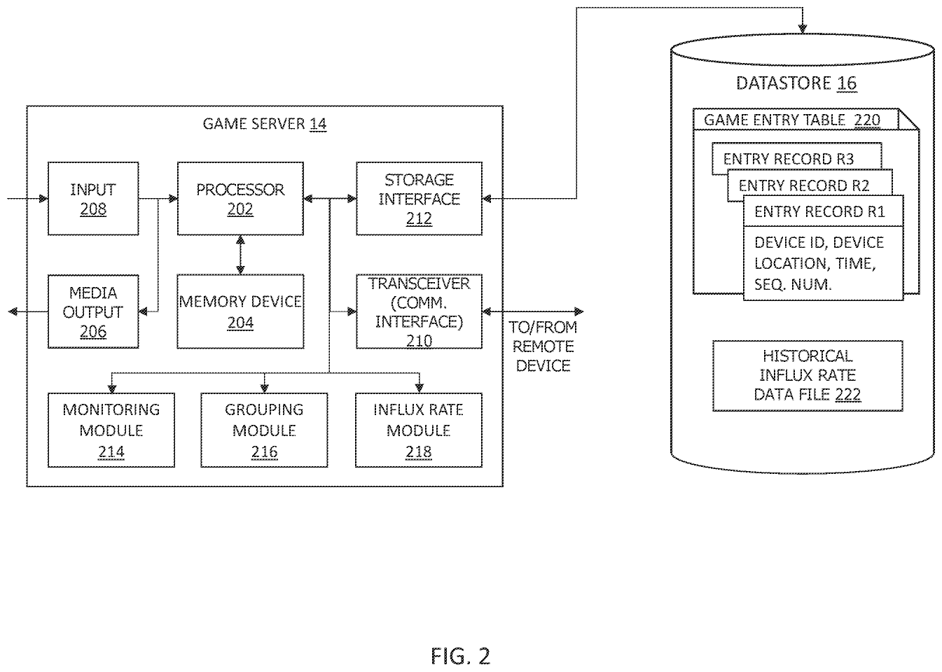

FIG. 2 is an example configuration of the game server 14, which is part of the gaming service provider 12 (shown in FIG. 1), in accordance with one aspect of the present disclosure. In the exemplary embodiment, the game server 14 is a computing device configured to connect to one or more of the gaming transaction devices 20, the user devices 22, and any other computing devices, such as other user computing devices (not shown), via the network 18.

In the example embodiment, the game server 14 includes one or more processors 202 for executing instructions. In some embodiments, executable instructions are stored in a memory device 204. The processor 202 may include one or more processing units arranged, for example, in a multi-core configuration. The memory device 204 is any device allowing information such as executable instructions, data, and/or written works to be stored and retrieved. The memory device 204 includes one or more computer readable media. The processor 202 is operable to execute the executable instructions, contained in program instructions, operations, and/or steps described herein, so as to control the game server 14 to provide desired functionality.

The game server 14 also includes at least one media output component 206 for presenting information to a user (not shown). The media output component 206 is any component capable of conveying information to the user. In some embodiments, the media output component 206 includes an output adapter such as a video adapter and/or an audio adapter. An output adapter is operatively coupled to the processor 202 and operatively connectable to an output device such as a display device, a liquid crystal display (LCD), light emitting diode (LED) display, organic light emitting diode (OLED) display, “electronic ink” display, etc. and/or an audio output device, such as a speaker, or headphones.

In some embodiments, the game server 14 includes an input device 208 for receiving input from the user. The input device 208 may include, for example, a touch sensitive panel, a touch pad, a touch screen, a stylus, a keyboard, a pointing device, a mouse, and/or an audio input device. A single component such as a touch screen may function as both an output device of the media output component 206 and the input device 208.

The game server 14 also includes a transceiver 210 (broadly, a communication interface), which is communicatively connectable to one or more remote computing devices such as the gaming transaction devices 20, the user devices 22, and any other computing devices via, for example, the network 18 (shown in FIG. 1). The transceiver 210 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like. The transceiver 210 may include numerous communication ports (not shown) to enable the game server 14 to communicate simultaneously with a number of other computers and other devices, including communications as required to simultaneously handle numerous transactions.

Stored in the memory device 204 are, for example, computer readable instructions for providing a user interface to the user via the media output component 206 and, optionally, receiving and processing input from the input device 208. A user interface may include, among other possibilities, a web browser and various software applications. Web browsers enable users to display and interact with media and other information typically embedded on a web page or a website. The various software applications allow the user to interact with the game server 14 to further communicate with the gaming transaction devices 20, the user devices 22, etc. to facilitate providing various gaming services to the user 24.

The memory device 204 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

The datastore 16 is any computer-operated hardware suitable for storing and/or retrieving data. In some embodiments, the datastore 16 is integrated in the game server 14. In other embodiments, the datastore 16 is external to the game server 14. For example, the game server 14 may include one or more hard disk drives as the datastore 16. In other embodiments, the datastore 16 is external to the game server 14 and may be accessed by a plurality of database servers. For example, the datastore 16 may include multiple storage units such as hard disks or solid-state disks in a redundant array of inexpensive disks (RAID) configuration. The datastore 16 may include a storage area network (SAN) and/or a network attached storage (NAS) system.

In some embodiments, the processor 202 is operatively coupled to the datastore 16 via a storage interface 212. The storage interface 212 is any component capable of providing the processor 402 with access to the datastore 16. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the datastore 16.

In some embodiments, it is contemplated that the game server 14 is implemented as a software application. In such embodiments, the hardware described above, such as the processor 202, the memory device 204, the transceiver 210, and/or the storage interface 212 may be shared with the hardware components of another database server (not shown).

The game server 14 also includes a monitoring module 214, which is programmed to monitor the network connections with the gaming transaction devices 20 and the user devices 22 to identify entry request data packets received from the gaming transaction devices 20 and the user devices 22, where the entry request data packets are transmitted as data signals in response to input from a user, such as the user 24 (shown in FIG. 1). Each entry request data packet relates to at least one game entry request and includes a plurality of data, including for example, at least a device ID, device location, time the entry request was generated, a sequence number (e.g., for multiple game entry requests received in a single request data packet), and/or a game identifier.

The monitoring module 214 extracts the data from the data packets and writes the received data to one or more tables stored on the datastore 16, such as game entry table 220, as an entry record. In one suitable embodiment, the game entry table 220 includes, for example, a plurality of rows or records, such as entry records R₁, R₂, R₃. Each of the entry records R₁, R₂, R₃ is associated with a respective device ID and includes, for example, a plurality of data fields (e.g., columns of the table). The data fields include, for example, and without limitation, at least a field for the device ID, the device location, the time of the entry request, the sequence number(s) (e.g., for multiple entries received in a single request), and the game ID.

A grouping module 216 is programmed to group the gaming transaction devices 20 and user devices 22 into various groups for the execution of one or more games. For example, in one suitable embodiment, the grouping module 216 selects a subset of the gaming transaction devices 20 and user devices 22 for a first game (e.g., a raffle drawing) using the entries received via the entry request data packets only for the selected subset of devices. The groups may be of various sizes and include entries of various users received from different devices. Furthermore, as described herein, the gaming service provider 12 may program the game server 14 to designate the various groups for the execution of one or more games, via the grouping module 216, based on any number of factors, gameplay styles, marketing, and/or promotional desires.

The game server 14 also includes an influx rate module 218 programmed to determine a device influx rate of entry request data packets for each of the gaming transaction devices 20 and user devices 22. The device influx rate includes, for example, and without limitation, a number of games entries requested by the respective device over a pre-determined period, such as a number of game entries per minute or hour and the like. Alternatively or in addition, in some suitable embodiments, the influx rate module 218 is also programmed to determine a group influx rate that includes a number of game entries requested over a pre-determined period and also per a selected population group (e.g., entries per minute, per one hundred thousand (100,000) people), or a selected group of two or more gaming transaction devices 20 and user devices 22.

The influx rate module 218 may be programmed to provide a current influx rate for each device and/or group over a specified predetermined period, such as intervals of thirty (30) seconds, one (1) minute, five (5) minutes, etc. The current influx rate may be written to memory device 204, for example, is a user accessible portion of the memory, so that a user can access the memory to quickly determine the device influx rate or group influx rate of entries. Alternatively or in addition, the influx rate module 218 may be programmed to write the current device influx rate and each newly determined device influx rate to a historical influx rate data file 222. The historical influx rate data file 222 may be used by the processor 202, along with other data, to predict a device influx rate and/or group influx rate of entry request at a period in the future.

In the exemplary embodiment, the datastore 16 stores one or more programs for controlling the processor 202. The programs include program instructions, operation, and/or steps (which may be referred to as computer-readable instructions) that contain executable operations of the game server 14. When the processor 202 executes the computer-readable instructions, it causes the game server 14 to function as described herein.

The programs include, for example, one or more conventional operating systems (not shown) that control the processor 202 so as to manage and coordinate activities and sharing of resources in the wallet game server 14, and to serve as a host for application programs that run on the game server 14. The one or more conventional operating systems include, for example, and without limitation, UNIX, LINUX, Microsoft Windows®, macOS®, OS X®, etc. More specifically, the computer-readable instructions may cause various data manipulations on data stored in the datastore 16 (e.g., create, read, update, and delete procedures). It should also be appreciated that upon initiation of a computer-based method, various computer-readable instructions may be executed during initialization. Some operations may be required to perform one or more processes described herein, while other operations may be more general and/or specific to a programming language (e.g., C, C#, C++, Java, or other suitable programming languages, etc.).

The datastore 16 may include, for example, a user registration application that, when executed by the processor 202, enables the game server 14 to handle requests from users, such as the user 24 (shown in FIG. 1), to register for gaming services provided by the game server 14. Using the user registration application, the user 24 may create his or her gaming account. The gaming account operates to allow the user 24 to participate in one or more games offered by the gaming service provider 12 and operated by the game server 14.

In addition, the datastore 16 may include a transaction processing application for executing payment transactions on behalf of the user 24. The transaction processing application may receive payment device details from a user, for example, via his or her user device 22, for purchasing entries for one or more games. For example, in one embodiment, the transaction processing application may read payment card account details from the user's digital wallet stored on the user device 22 and generate one or more payment authorization requests that are routed to an appropriate payment system (not shown).

The user 24 may register for a gaming account with the gaming service provider 12 by interacting with a webpage that is hosted by the gaming service provider 12. After the user 24 has established his or her account via the webpage, he or she may add payment details for purchasing game entries from the game server 14. For example, the user 24 may add one or more of his or her payment cards and/or accounts to his or her gaming account. In one suitable embodiment, the user 24 authorizes the gaming server provider 12 to contact card issuers of the payment card accounts to initiate a process of inputting the relevant payment account data into a digital wallet stored with the user's gaming account.

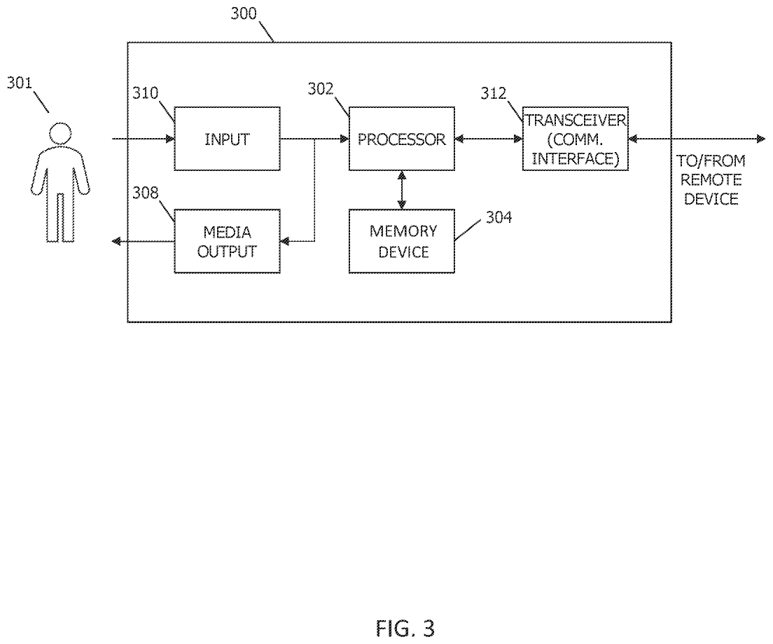

FIG. 3 is an example configuration of a client system 300 operated by a user 301. In some embodiments, the client system 300 is a gaming transaction device 20 and/or a user device 22 (each shown in FIG. 1). In addition, the user 301 may be the user 24 (shown in FIG. 1).

In the example embodiment, the client system 300 includes one or more processors 302 for executing instructions. In some embodiments, executable instructions are stored in a memory device 304. The processor 302 may include one or more processing units arranged, for example, in a multi-core configuration. The memory device 304 is any device allowing information such as executable instructions, data, and/or written works to be stored and retrieved. The memory device 304 includes one or more computer readable media.

The client system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the client system 300 includes an input device 310 for receiving input from the user 301. The input device 310 may include, for example, a touch sensitive panel, a touch pad, a touch screen, a stylus, a photographic element or camera, an optical sensor, a gyroscope, an accelerometer, a position detector, a keyboard, a pointing device, a mouse, or an audio input device. A single component such as a touch screen may function as both an output device of the media output component 308 and the input device 310. The client system 300 may also include a transceiver 312 (broadly, a communication interface), which is communicatively connectable to a remote device such as the game server 14 (shown in FIG. 1). The transceiver 312 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. The user interface may include, among other possibilities, a web browser and various software applications. Web browsers enable users to display and interact with media and other information typically embedded on a web page or a website. The various software applications allow the user 301 to interact with the client system 300 to further communicate with the game server 14, other user mobile devices, other client systems, payment system, etc. to facilitate purchasing game entries and/or providing game play to the user 301 and, optionally, execute a transaction upon delivery of such services.

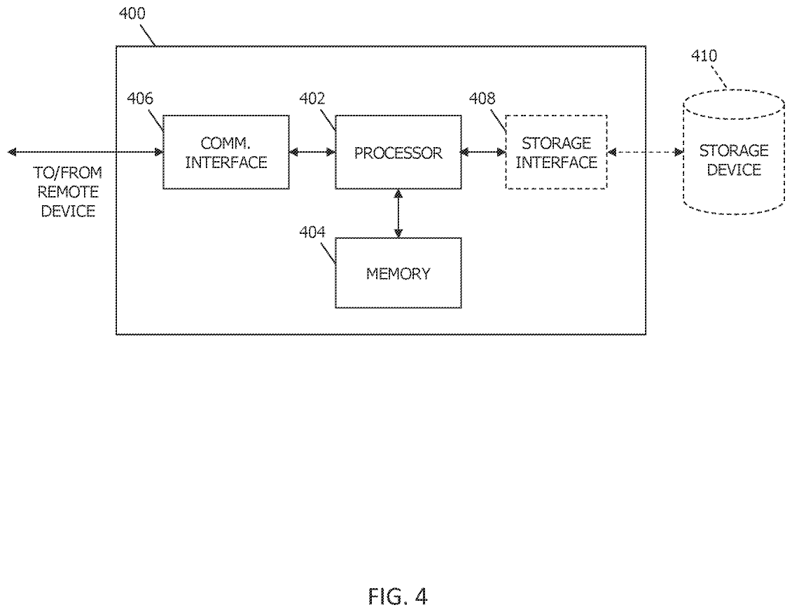

FIG. 4 is an example configuration of a server system 400, such as the gaming service provider 12 (shown in FIG. 1). In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as the gaming transaction devices 20, the user devices 22, the game server 14, a client system 300, or another server system. For example, the communication interface 406 may receive communications from the gaming transaction devices 20 and the game server 14.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is like a transaction database. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In some embodiments, it is contemplated that the server system 400 is implemented as a software application. In such embodiments, the hardware described above, such as the processor 402, the memory area 404, the communication interface 406, and/or the storage interface 408 may be shared with the hardware components of a client system 300, such as the processor 302, the memory device 304, and/or the transceiver 312.

### Exemplary Gaming Scenarios & Computer-Implemented Methods

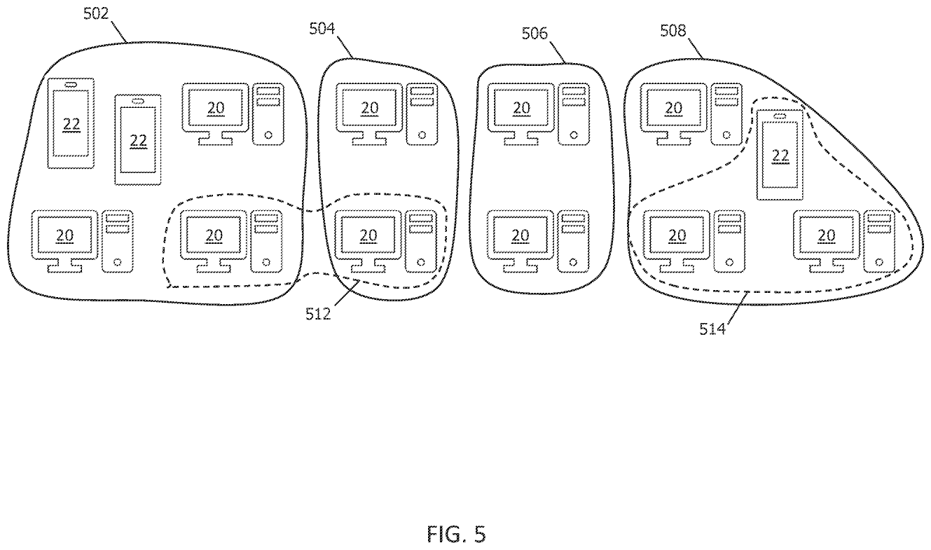

FIG. 5 is a schematic illustration of groupings 502, 504, 506, and 508 of a plurality of gaming transaction devices 20 and user devices 22. As described above, the gaming transaction devices 20 and user devices 22 may be associated with requesting one or more entries for a raffle-type and/or lottery style game. The game service provider 12 (shown in FIG. 1) selects a predetermined number of entries in response to a triggering event, wherein the selection criteria is based on one or more rules and/or conditions. In one example, the triggering event may include the distribution of game entries sufficient to execute two (2) games. For example, in one suitable embodiment, if a raffle-type and/or lottery style game is specified to include a drawing of a single entry from two hundred thousand (200,000) entries, then a triggering event may be the distribution a four hundred thousandth (400,000) entry (the distributed entries being sufficient for two (2) games).

In certain embodiments, the rate of game entry requests (e.g., via the received entry request data packets) may be high with respect to certain gaming transaction devices 20 and user devices 22 and quite low with respect to other gaming transaction devices 20 and user devices 22. As such, it may be desirable to trigger a game for those gaming transaction devices 20 and user devices 22 with higher entry influx rates as opposed to those with lower influx rates. In this manner, game players in population dense areas that may be associated with higher game entry influx rates may be rewarded with the awarding of a prize earlier in time, thus resulting in higher player satisfaction due to immediacy of gaming outcomes. Thus, the grouping module 216 (shown in FIG. 2) may select a group of gaming transaction devices 20 and user devices 22 that have a sufficient number of entries to execute the game and also have a higher influx rate of entry requests. While described above as selecting groupings based, in part, on influx rates, it is noted that grouping criteria may include one or more rules and/or conditions, which may include, for example, and without limitation, game pools or geographic locations based on any number of factors, gameplay styles, marketing, and/or promotional desires.

In the embodiment shown in FIG. 5, the groupings 502, 504, 506, and 508 may be determined, for example, by the grouping module 216, based on a parameter such as geolocation of the gaming transaction devices 20 and the user devices 22. For example, in the illustrated embodiment, the grouping 502 may include only those gaming transaction devices 20 and user devices 22 located in the Pacific time zone of the United States (U.S.). In the same vein, the grouping 504 may represent those devices in the Mountain time zone, grouping 506 may represent those devices in the Central time zone, and the grouping 508 may represent those devices in the Eastern time zone. Such a grouping may illustrate different entry influx rates based on the different times associated with the time zones. For example, game entry requests may begin to increase in the morning in the grouping 508 as people begin their day, whereas at the same time, entry requests from the grouping 502 may be quite low due to the time being four (4) hours earlier for player in that grouping. It is noted that any predetermined criteria may be used to define one or more groupings of the gaming transaction devices 20 and user devices 22. For example, in a certain embodiment, the predetermined criteria may be associated with certain geographic areas (e.g., countries, states, etc.) or gaming jurisdictions. Further, as noted above, in other embodiments, the predetermined criteria may include, for example, and without limitation, game pools or geographic locations based on any number of factors, gameplay styles, marketing, and/or promotional desires.

Furthermore, in certain embodiments, the grouping module 216 may also define one or more subgroupings, such as subgroupings 512 and 514. Each subgrouping, such as subgroupings 512 and 514, may be defined in a single grouping or may span more than one (1) grouping, as indicated in FIG. 5. In one suitable embodiment, the subgroupings 512 and 514 may be based on one or more parameters, including for example, the geolocation of the devices and a device influx rate of game entry requests for the individual gaming transaction devices 20 and user devices 22. As such, if a certain number of gaming transaction devices 20 are processing game entry requests at a higher rate than other devices, those higher influx rate may be selected to define a gaming subgroup.

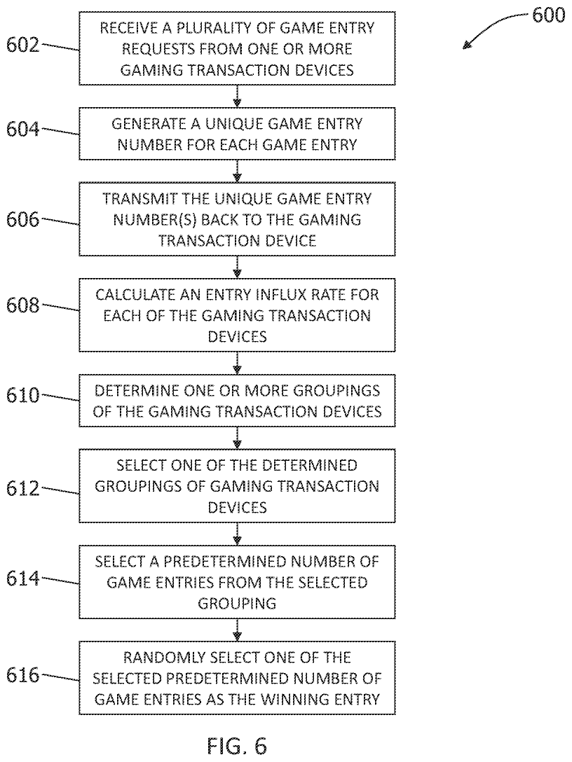

FIG. 6 is a flowchart illustrating an exemplary computer-implemented method 600 for a raffle-type and/or lottery style game based on game entry influx rate, in accordance with one embodiment of the present disclosure. The operations described herein may be performed in the order shown in FIG. 6 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 600 is described below, for ease of reference, as being executed by exemplary devices and components introduced with the embodiments illustrated in FIGS. 1-5. In one embodiment, the computer-implemented method 600 is implemented by the game server 14 (shown in FIG. 2). In the exemplary embodiment, the computer-implemented method 600 relates to triggering a raffle-type and/or lottery style game in response to a triggering event and game entry influx rates of various entry requesting devices. While operations within the computer-implemented method 600 are described below regarding the game server 14, according to some aspects of the present invention, the computer-implemented method 600 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 602, in the example embodiment, the game server 14 receives a plurality of game entry request data packets from one or more gaming transaction devices 20 and user devices 22 (shown in FIG. 1). The monitoring module 214 (shown in FIG. 2) monitors each request packet, extracts the data contained therein, and writes the data (i.e., respective game entry requests) to the game entry table 220 (shown in FIG. 2) as one or more entry records, such as such as entry records R₁, R₂, R₃. Each entry request (and therefore, entry record) includes, for example, a device ID of the requesting gaming transaction device 20 or user device 22, a device location (e.g., geo-location data (e.g., GPS location, country, city, etc.)), time of the request transaction, a sequence number, and a game ID. In one suitable embodiment, the device ID includes, for example, an IP address, a physical address associated with an IP address, a device type, a phone number, a device hardware identifier (e.g., a serial number, an IMEI or MEID number, etc.), and the like. The sequence number may include a serial sequence number for each entry requested in the entry request. For example, if a game player, such as the game player 24, wishes to obtain five (5) entries in a single transaction, the entry request transmitted by the gaming transaction device 20 or user device 22 may include a sequence number (e.g., 1, 2, 3, 4, and 5) associated with each entry request. The game ID may include an identifier associated with a specific game (e.g., one of a series of subsequent games, a selected game at a specific time/date, etc.). In one aspect of the present invention, the game player 24 may select to “pre-play” or enter into a game “subscription service.” For example, the game player 24 may select to play in ten (10) consecutive games rather than selecting multiple entries in the next immediate game.

At operation 604, the game server 14 combines two or more of the device ID, device location, time, and sequence number together for each game ID to generate a unique game entry number for each game entry. The unique game entry number is stored with its respective entry request record in the game entry table 220. At operation 606, the game server 14 transmits the unique game entry number(s) back to the gaming transaction device 20 or user device 22 from which the entry request was received. In one suitable example, the gaming transaction device 20 may print a game ticket including the unique game entry number(s) for the game player 24, for each selected game ID. The user device 22 may store the unique game entry number(s) for later retrieval by the game player 24.

At operation 608, the influx rate module 218 (shown in FIG. 2) of the game server 14 calculates an entry influx rate for each of the gaming transaction devices 20 and user devices 22 (e.g., a device influx rate), based in part, on the game ID. The current entry influx rate for each device, with respect to each game ID, is stored in the memory device 204. If there is an existing entry influx rate for a respective device already stored in the memory device 204, that number is written to the historical influx rate data file for later retrieval. The current entry influx rate for the respective device is then written over the previous entry influx rate. In this manner, the game server 14 or a user of the game server 14 can determine the instant entry influx rate for a given gaming transaction device 20 and user device 22 for a given game ID.

At operation 610, the game server, and more particularly, the grouping module 216 (shown in FIG. 2), determines one or more groupings of the gaming transaction devices 20 and user devices 22. For example, based on one or more predefined rules and/or conditions, the grouping module 216 defines various groupings of the gaming transaction devices 20 and user devices 22. The predefined rules and/or conditions include, for example, and without limitation, a geolocation, a device influx rate, a predetermined time, gameplay style, marketing and/or promotional desires, and the like.

In one embodiment, the influx rate module 218 also determines a current influx rate for the defined groupings (e.g., a group influx rate) based upon the device influx rates of the gaming transaction devices 20 and/or user devices 22 in the group, as determined by the grouping module 216. In this manner, the game server 14 can determine an optimal grouping and/or subgrouping of the gaming transaction devices 20 and user devices 22 for executing the raffle-type and/or lottery style game. Thus, if game entry influx rate is substantially higher in one grouping than another, the game server 14 can execute a first game for the grouping with the higher influx rate and then, for a second game, adjust the groupings based on the then current number of entries and entry influx rates after the first game is executed.

At operation 612, based on a predetermined triggering event, the game server 14 selects one of the determined groupings of gaming transaction devices 20 and user devices 22, and from that selected grouping, at operation 614, selects a predetermined number of game entries (e.g., entry records) from the game entry table 220. The triggering event can include for example, a predetermined number of entry records being written to the game entry table. In addition, the predetermined number of game entries is determined by a user of the game server 14 and is based, in part, on the winning odds selected for the game. For example, for a raffle-type and/or lottery style game with selected odds of winning being one (1) in two hundred thousand (200,000), the predetermined number of game entries to be selected from the entry records is two hundred thousand (200,000). The selected number of game entries are taken from the earliest entries in time based on the transaction time of the entry request for the selected game ID. That is, in the example above, the first two hundred thousand (200,000) entries in time for a given game ID are selected for the raffle-type and/or lottery style game.

At operation 616, the game server 14 selects, at random, one of the selected predetermined number of game entries as the winning entry. For example, the game server 14 may include a pseudo-random number generator application that is executed to select one of the selected predetermined number of game entries. The game player 24 with the selected winning entry is then awarded a prize.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A server comprising:
a database comprising a game entry table having a plurality of game entry records;
a communication interface communicatively connectable to a network;
a monitoring module configured to monitor the network connection;
a grouping module;
an influx rate module; and
a processor coupled in communication with said database, communication interface, monitoring module, grouping module, and influx rate module, said processor programmed to:
receive a plurality of game entry request data packets from one or more gaming transaction devices via the communication interface, each game entry request data packet including data, the data including a device identifier, a device location, a time of the request, and a sequence number for a game entry;
combine two or more of the device identifier, device location, time of the request, and sequence number to generate a unique game entry number for each game entry;
transmit the unique game entry number for each game entry to the requesting transaction device via the communication device;
calculate a first entry influx rate for each of the gaming transaction devices using the influx rate module;
determine one or more groupings of the gaming transaction devices using the grouping module, the one or more groupings based on one or more predefined rules and the first entry influx rate for each of the gaming transaction devices;
in response to a triggering event, select one of the groupings and, from the selected grouping, a predetermined number of unique game entry numbers; and
select one of the unique game entry numbers from the selected predetermined number of unique game entry numbers.

2. The server in accordance with claim 1,
said monitoring module programmed to monitor the network connection, identify the plurality of game entry request data packets, extract the data from the plurality of game entry request data packets, and write the data to the game entry table.

3. The server in accordance with claim 2,
said monitoring module programmed to write the data to the game entry table as one or more entry records,
each entry record corresponding to the device identifier, device location, time of the request, and sequence number for a respective game entry.

4. The server in accordance with claim 1,
said processor further programmed to:
calculate a second entry influx rate for each of the gaming transaction devices using the influx rate module;
determine one or more subgroupings of the gaming transaction devices using the grouping module, the one or more subgroupings based on one or more predefined rules and the second entry influx rate for each of the gaming transaction devices; and
in response to the triggering event, select one of the subgroupings and, from the selected subgrouping, a predetermined number of unique game entry numbers.

5. The server in accordance with claim 1,
said processor further programmed to calculate, using the influx rate module, a first grouping entry influx rate for the one or more groupings based upon the respective first entry influx rates for each of the gaming transaction devices grouped into the one or more groupings.

6. The server in accordance with claim 1, wherein the triggering event comprises a predetermined number of entry records written to the game entry table.

7. The server in accordance with claim 1,
said server further comprising a pseudo-random number generator application,
said processor programmed to execute the pseudo-random number generator application to select one of the unique game entry numbers from the selected predetermined number of unique game entry numbers.

8. The server in accordance with claim 1,
said influx rate module programmed to calculate the first entry influx rate for each of the gaming transaction devices over a predetermined period.

9. The server in accordance with claim 8, wherein the specified period includes one of the following period intervals: thirty (30) seconds, one (1) minutes, and five (5) minutes.

10. The server in accordance with claim 1,
said influx rate module further programmed to write the first entry influx rate of the gaming transaction devices to a historical influx rate data file.

11. A method performed by a server, said method comprising:
receiving a plurality of game entry request data packets from one or more gaming transaction devices via a communication interface, each game entry request data packet including data, the data including a device identifier, a device location, a time of the request, and a sequence number for a game entry;
combining two or more of the device identifier, device location, time of the request, and sequence number to generate a unique game entry number for each game entry;
transmitting the unique game entry number for each game entry to the requesting transaction device via the communication device;
calculating a first entry influx rate for each of the gaming transaction devices using an influx rate module;
determining one or more groupings of the gaming transaction devices using a grouping module, the one or more groupings based on one or more predefined rules and the first entry influx rate for each of the gaming transaction devices;
selecting one of the groupings in response to a triggering event;
selecting a predetermined number of unique game entry numbers from the selected grouping; and
selecting one of the unique game entry numbers from the selected predetermined number of unique game entry numbers.

12. The method in accordance with claim 11, further comprising:
monitoring the network connection with a monitoring module;
identifying the plurality of game entry request data packets;
extracting the data from the plurality of game entry request data packets; and
writing the data to the game entry table.

13. The method in accordance with claim 12, wherein writing the data to the game entry table comprise writing the data to the game entry table as one or more entry records, each entry record corresponding to the device identifier, device location, time of the request, and sequence number for a respective game entry.

14. The method in accordance with claim 11, further comprising:
calculating a second entry influx rate for each of the gaming transaction devices using the influx rate module;
determining one or more subgroupings of the gaming transaction devices using the grouping module, the one or more subgroupings based on one or more predefined rules and the second entry influx rate for each of the gaming transaction devices; and
selecting one of the subgroupings in response to the triggering event; and
selecting a predetermined number of unique game entry numbers from the selected subgrouping.

15. The method in accordance with claim 11, further comprising,
calculating a first grouping entry influx rate for the one or more groupings based upon the respective first entry influx rates for each of the gaming transaction devices grouped into the one or more groupings.

16. The method in accordance with claim 11, wherein the triggering event comprises a predetermined number of entry records written to the game entry table.

17. The method in accordance with claim 11, further comprising,
executing a pseudo-random number generator application to select one of the unique game entry numbers from the selected predetermined number of unique game entry numbers.

18. The method in accordance with claim 11, wherein calculating the first entry influx rate for each of the gaming transaction devices comprises calculating the first entry influx rate for each of the gaming transaction devices over a predetermined period.

19. The method in accordance with claim 18, wherein the specified period includes one of the following period intervals: thirty (30) seconds, one (1) minutes, and five (5) minutes.

20. The method in accordance with claim 11, further comprising,
writing the first entry influx rate of the gaming transaction devices to a historical influx rate data file.
